(19) United States
(12) Patent Application Publication
(10) Pub. No.: US 2023/0403236 A1
(43) Pub. Date: Dec. 14, 2023

(54) TECHNIQUES TO SHAPE NETWORK TRAFFIC FOR SERVER-BASED COMPUTATIONAL STORAGE

(71) Applicant: Intel Corporation, Santa Clara, CA (US)

(72) Inventors: Michael MESNIER, Scappoose, OR (US); Anil VASUDEVAN, Portland, OR (US); Kelley MULLICK, Hillsboro, OR (US)

(21) Appl. No.: 18/238,345

(22) Filed: Aug. 25, 2023

(51) Int. Cl. H04L 47/2425; H04L 47/52; H04L 47/22; H04L 67/1097

(52) U.S. Cl. CPC H04L 47/2433; H04L 47/522; H04L 47/22; H04L 67/1097

(57) ABSTRACT

Examples include techniques to shape network traffic for server-based computational storage. Examples include use of a class of service associated with a compute offload request that is to be sent to a computational storage server in a compute offload command, The class of service to facilitate storage of the compute offload command in one or more queues of a network interface device at the computational storage server. The storage of the compute offload command to the one or more queues to be associated with scheduling a block-based compute operation for execution by compute circuitry at the computational storage server to fulfill the compute offload request indicated in the compute offload command.

### TECHNICAL FIELD

Examples described herein are generally related to shaping network traffic for server-based computational storage in disaggregated environments.

### BACKGROUND

Computational storage research has been around for decades, but only recently has the data center industry pushed to bring it to production. Advancements in computational storage strive to bring computation closer to the data, to reduce input/output (I/O) bottlenecks and to accelerate computation. Benefits of computational storage can be enticing to cloud service providers (CSPs) and storage vendors alike. Computational storage can be enticing given that on average, nearly 65% of total system energy is spent on data movement in data centers arranged to support CSPs. Recent adoption of data-intensive applications and fast, dense storage (e.g., pools of solid state drives (SSDs)), can further drive a need for reduced data movement through a network.

### BRIEF DESCRIPTION OF THE DRAWINGS

FIG. 1 illustrates an example of a host and target system.

FIG. 2 illustrates an example compute offload command.

FIG. 3 illustrates an example of a queue system for use in the host and target system.

FIG. 4 illustrates an example policy table.

FIG. 5 illustrates an example first process flow.

FIG. 6 illustrates an example second process flow.

FIG. 7 illustrates an example compute server system.

FIG. 8 illustrates an example computational storage server system.

### DETAILED DESCRIPTION

Data centers are shifting from deploying monolithic applications to applications composed of communicatively coupled microservices. Applications can be composed of microservices that are independent, composable services that communicate through application program interfaces (APIs) and are typically hosted by a compute server that runs application code and user file systems. Computational storage servers (as opposed to single computational storage devices, like a single SSD) can improve microservices via reduced data congestion. Compute servers coupled with computational storage servers through a network can represent a disaggregated storage solution. This disaggregated storage solution may utilize transport protocols such as, but not limited to, non-volatile memory express (NVMe) over fabrics (NVMe-oF) transport protocols that can operate consistent with the NVMe Specification, Rev. 2.0b, published Jan. 6, 2022, the NVMe-oF Specification, Rev. 1.1a, published Jul. 12, 2021, and/or prior or subsequent revisions of either the NVMe-oF specification or the NVMe specification.

In some examples for a disaggregated storage solution, a disaggregated hardware/software stack can leverage compute circuitry and/or resources (e.g., accelerators) at a computational storage server to efficiently move data used for or produced by computations associated with microservices or reduce data movement by processing the data at the computational storage server and only sending back result data that is substantially smaller than the data that was processed. The efficient movement of data can involve the shaping of network traffic between a computational server and a computational storage server in a manner that can reduce latency for executing microservices workloads in a data center. Along with reduced latency, dataflow congestion can also be reduced and dynamic shifts in microservices workload performance and memory/storage needs can be addressed. As contemplated by this disclosure and described more below, rather than change basic block storage protocols, an approach that extends the block storage protocols with compute descriptors that describe locations of file data (blocks), operations to be performed, and a class of service can enable network traffic between a compute server and a computational storage server to be shaped. An ability to shape the network traffic can improve both performance and variability of network I/O. This can be especially important in microservice environments, where multiple tenants are competing for resources.

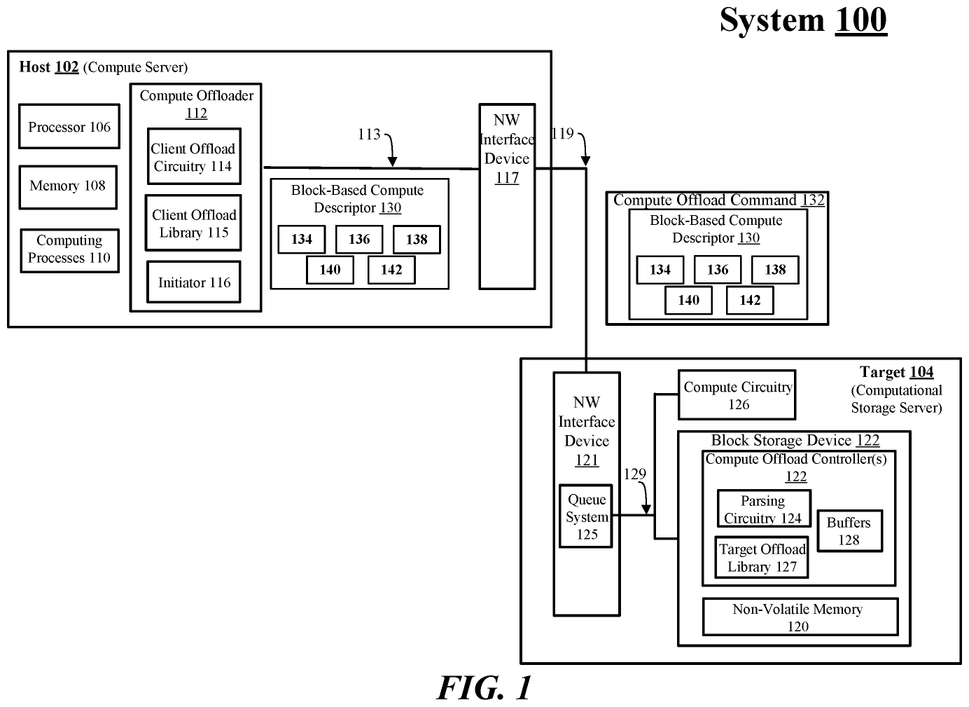

FIG. 1 illustrates an example system 100. In some examples, as shown in FIG. 1, system 100 can include a host 102 coupled through a network (NW) interface device 117 via a communication link 119 with a target 104. Also, host 102 may include a processor 106 coupled with a memory 108. In some examples, a plurality of computing processes 110 can run on host 102 (e.g., supported by processor 106 and memory 108). Computing processes 110 can include one or more applications (e.g., a microservice applications), storage middleware, software storage stacks, operating systems, or any other suitable computing processes. In some examples, host 102 can also include a compute offloader 112 that can include client offload circuitry 114 and an initiator 116. In some examples, host 102 can be referred to as a compute server and target 104 can be referred to as a computational storage server.

According to some examples, a computing process from among computing processes 110 can send a compute offload request to a compute offloader 112. In various examples, the compute offload request may specify a higher-level object (e.g., a file), a desired operation (e.g., a hash function such as an MD5 operation), and a class of service to differentiate the request from other compute offload requests. Client offload circuitry 114 can include logic and/or features that can be arranged to construct a block-based compute descriptor 130 based at least in part on the request. Client offload circuitry 114 can also include logic and/or features that can be arranged to generate a virtual input object 134 based at least in part on the higher-level object specified by the compute offload request. Client offload circuitry 114 may determine a list of one or more blocks corresponding to where the higher-level object is stored in block-based storage (e.g., non-volatile memory at target 104) to generate virtual input object 134.

In some examples, block-based compute descriptor 130 can describe the storage blocks (e.g., as mapped by virtual objects) that are to be input and/or output for a compute operation indicated by a function 138 (e.g., a requested compute offload operation as identified by a compute type identifier or an operation code) to be executed, any additional arguments 140 to function 138 (e.g., a search string) and a class of service 142 to differentiate the request for the computation from other compute offload requests. Additional arguments 140 can also be referred to as parameters. In some embodiments, compute offloader 112 can include a client offload library 115 that can be used by logic and/or features of client offload circuitry 114 to create or generate block-based compute descriptor 130. In some examples, client offload library 115 may not be present and/or some or all aspects of client offload library 115 can be included in client offload circuitry 114 (e.g., in an application specific integrated circuit (ASIC) or field programmable gate array (FPGA)). The logic and/or features of client offload circuitry 114 can be arranged to create virtual input objects 134 and/or virtual output objects 136 (e.g., lists of block extents and object lengths), assign an operation code or function for the desired compute operation to be performed with these virtual objects, and indicate a class of service to differentiate the compute offload request for the desired compute operation. Block-based compute descriptor 130 can be arranged to describe block-based compute operations in a protocol agnostic fashion that can work for any block-based storage device or system that includes, for example, non-volatile memory. In some examples, virtual input object 134 can include a first set of metadata that maps virtual input object 134 to a real input object (e.g., a file). For these examples, the first set of metadata can include a size of the real input object, a list of blocks composing the real input object, and/or any other metadata that describes the real input object. Virtual output object 136 can include a second set of metadata that maps the virtual output object 136 to a real output object.

In some examples, general purpose, file-based computation in block-based storage can be executed and/or all execution context can be carried within a single I/O command. For example, the single I/O command is shown in FIG. 1 as compute offload command 132 that is sent from NW interface device 117 at host 102 over communication link 119 to target 104. As described more below, block-based compute descriptor 130 can be packaged in compute offload command 132 in a vendor-specific command format to generate a single I/O command. The single I/O command can provide performance advantages over conventional approaches that require multiple roundtrips between (e.g., communication between) host 102 and target 104 via communication link 119 in order to initiate a target-side computation and/or conventional approaches that have scheduling overhead that grows (e.g., linearly) with the number of blocks in a file. The single I/O command can also reduce data movement by processing the data at target 104 and only sending back result data to host 102 that is substantially smaller than the data that was processed. By carrying all execution context within a single I/O command, various advantages over conventional approaches that use programmable filters that persist across READ operations and/or require separate initialization and finalization commands (e.g., introduce state tracking overhead to SSD operations) can occur. Some examples may not require an introduction of an object-based file system anywhere on a host (e.g., host 102), which may reduce complexity in comparison to conventional approaches. Some examples can provide a general purpose solution that may be suitable for use with any file system, and may function with object-based storage stacks, in contrast with some conventional approaches that require applications to have direct access to block storage and/or that are not suitable for use with a file system.

In some examples, initiator 116 can be arranged to cause information included in block-based compute descriptor 130 to be forwarded to NW interface device 117 over communication link 113 (e.g., via a Peripheral Component Interconnect Express (PCIe) or via a Compute Express Link (CXL)). As described more below, an inclusion of class of service 142 in block-based compute descriptor 130 can create a signature for compute offload command 132 via which logic and/or features at a queue system 125 maintained at NW interface device 121 at target 104 can allocate an appropriate queue to a compute offload command 132 received via communication link 119 in order to differentiate a compute offload request included in compute offload command 132 from other compute offload requests allocated to queues included in queue system 125. Class of service 142, for example, can also differentiate from regular I/O requests such as READ and WRITE requests that may not be associated with a compute offload request. Queue system 125, for example, can be configured according to an Intel® technology known as Application Device Queue (ADQ) and includes a plurality of queues (not shown in FIG. 1). Logic and/or features of queue system 125 (also not shown in FIG. 1) can group compute offload commands together based on a class of service and allocate one or more of the plurality of queues based on that grouping. The allocated one or more queues can be assigned a same identifier such as, but not limited to, a New API (NAPI) identifier (NAPI_ID). Grouping compute offload commands having a same class of service for allocation of queues can reduce locking or stalling from contention for access to queues included in queue system 125. For example, class of service 142 may indicate a platinum, gold, silver or bronze class of service and the logic and/or features of queue system 125 can cause compute offload commands having a same class of service to be grouped together and allocate one or more queues having a same NAPI_ID to that class of service. This grouping, for example, can also allow for shaping of network traffic that includes compute offload command 132 to be routed through NW interface device 121 and to compute circuitry at target 104 to facilitate efficient movement of command offload requests in a manner that can reduce latency caused by queue contention and also can add some predictability to when a command offload request included in a compute offload command 132 is to be scheduled for execution by compute circuitry 126 at target 104. One or more policies can also be associated with a class of service indicated in class of service 142 such as, but not limited to a policy to traffic shape compute offload requests based on a respective limit to computational storage operations per second at target 104 that can be associated with the class of service indicated in class of service 142. Traffic shaping based on this policy, for examples, can dictate a number of queues to be allocated to grouped compute offload requests having the class of service indicated in class of service 142 and/or dictate when allocated queues can be made available for that particular class of service.

According to some examples, communication link 119 can be a fabric arranged to operate according to various storage related technologies to include, but not limited to, internet small computer system interface (iSCSI) or NVMe-oF, or any other suitable storage related technology to transmit command offload requests.

In some examples, as shown in FIG. 1, target 104 includes NW interface device 121, a block storage device 122 and compute circuitry 126. Block storage device 122, as shown in FIG. 1, can be coupled with NW interface device 121 via a communication link 129 (e.g., a PCIe or a CXL link). Block storage device can include a non-volatile memory 120 and a compute offload controller(s) 122. In some examples, compute offload controller(s) 122 can be a non-volatile memory controller, a storage server controller, or any other suitable block-based storage controller or portion thereof. Although non-volatile memory 120 is shown as single element for clarity, it should be understood that multiple non-volatile memory 120 may be present in block storage device 122 and/or controlled at least in part by compute offload controller(s) 122. In some examples, compute offload controller(s) 122 can include parsing circuitry 124. Parsing circuitry 124 can include logic and/or features to parse a compute offload command (e.g., compute offload command 132) received from host 102 and stored to one or more queues included in queue system 125 at NW interface device 121. For these examples, the logic and/or features of parsing circuitry 124 can identify a block-based compute descriptor (e.g., block-based compute descriptor 130) packaged in a compute offload command (e.g., compute offload command 132), and parse the identified block-based compute descriptor to identify a virtual input object (e.g., virtual input object 134), a virtual output object (e.g., virtual output object 136), a requested compute offload operation (e.g., function 138), and/or other parameters (e.g., a search string specified by additional arguments 140). Compute circuitry 126 can then perform the requested compute offload operation. Compute circuitry 126 can perform the requested function 138, for example, against the virtual input object 134 and then cause a result of the requested compute operation to be stored in the virtual output object 136. One or more standard operations (e.g., read and write operations) of non-volatile memory 120 can continue to normally occur while the offloaded compute operation is performed by compute circuitry 126.

According to some examples, compute offload controller(s) 122 can include a target offload library 127 that can be used by the logic and/or features of parsing circuitry 124 to parse the compute offload command and/or the block-based compute descriptor, and that can be used by compute circuitry 126 to perform the requested compute operation. Target offload library 127, in some examples, is not present and/or some or all aspects of target offload library 127 can be included in parsing circuitry 124 and/or compute circuitry 126. For example, offload library 127 can be included in a lookup table maintained at an ASIC or FPGA configured to support parsing circuitry 124 or compute circuitry 126.

In some examples, if one or more expected items are not included in a block-based compute descriptor (e.g., a virtual output object), a default value can be used or a default action can be performed, if possible. The various examples mentioned above that are related to block-based compute descriptors included in compute offload commands can avoid problems associated with conventional approaches that add complex object-based devices or object-based file systems by creating virtual objects in the block storage system and performing computation against the virtual objects. In some examples, parsing circuitry 124 can be referred to as a parser and compute circuitry 126 can be referred to as an offload executor.

According to some examples, virtual input object 134 included in block-based compute descriptor 130 can include a first list of one or more blocks. For these examples, the first list of one or more blocks can include a list of starting addresses and a corresponding list of block lengths to form a first set of block extents. Also, virtual output object 136 included in block-based compute descriptor 130 can include a second list of one or more blocks. The second list of one or more blocks can include a list of starting addresses and a corresponding list of block lengths to form a second set of block extents. In other examples, the first and/or second set of block extents can be specified with a list of starting addresses and a list of ending addresses, and/or can include a total virtual object length (virtual input object length or virtual output object length respectively). In some examples, requested function 138 included in block-based compute descriptor 130 can be a function (e.g., compression, hashing, searching, image resizing, checksum computation, word count, video transcoding, sorting, merging, de-duplication, filtering or any other suitable function) which can be applied to the first list of one or more blocks and written to the second list of one or more blocks. Blocks associated with virtual input object 134 and/or the virtual output object 136 can be sectors. The starting addresses, for example, can be logical block addresses (LBAs), the first and second lists one or more blocks can be otherwise identified by LBAs, or the first and/or second lists of one or more blocks can be identified in any other suitable manner. Virtual input object 134 can specify block locations in non-volatile memory 120 where file data is stored, and/or the virtual output object 136 can specify block locations in non-volatile memory 120 where a result is to be written. In some examples, virtual output object 136 can specify that the result is to be returned to host 102.

In various examples, parsing circuitry 124, compute circuitry 126, and/or other functions of compute offload controller(s) 122 can be performed with one or more processors or central processing units (CPUs), one or more FPGAs, one or more ASICs, one or more accelerators, an intelligent storage acceleration library (ISA-L), a data streaming architecture, and/or any other suitable combination of hardware and/or software, not shown for clarity.

According to some examples, as shown in FIG. 1, compute offload controller(s) 122 may include one or more buffers 128 that may include input buffers, output buffers, and/or input/output buffers in various examples. One or more components of compute offload controller(s) 122 (e.g., parsing circuitry 124) can use buffers 128 to facilitate read and/or write operations to non-volatile memory 120.

In some examples, host 102 and/or target 104 can include additional elements, not shown for clarity (e.g., target 104 can include one or more processors and system memory).

According to some examples, non-volatile memory 120 can be a type of memory whose state is determinate even if power is interrupted. Non-volatile memory 120 can include a plurality of block addressable mode memory devices that include memories design according to NAND or NOR technologies. For example, non-volatile memory 120 may include a plurality of SSD devices that include multi-threshold level NAND flash memory (for example, Single-Level Cell (“SLC”), Multi-Level Cell (“MLC”), Quad-Level Cell (“QLC”), Tri-Level Cell (“TLC”), or some other NAND). In some examples, non-volatile memory 120 can include a byte-addressable write-in-place three dimensional crosspoint memory device, or other byte addressable write-in-place non-volatile memory devices, such as single or multi-level Phase Change Memory (PCM) or phase change memory with a switch (PCMS), resistive memory including metal oxide base, oxygen vacancy base and Conductive Bridge Random Access Memory (CB-RAM), nanowire memory, ferroelectric transistor random access memory (FeTRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, a combination of any of the above, or other suitable memory.

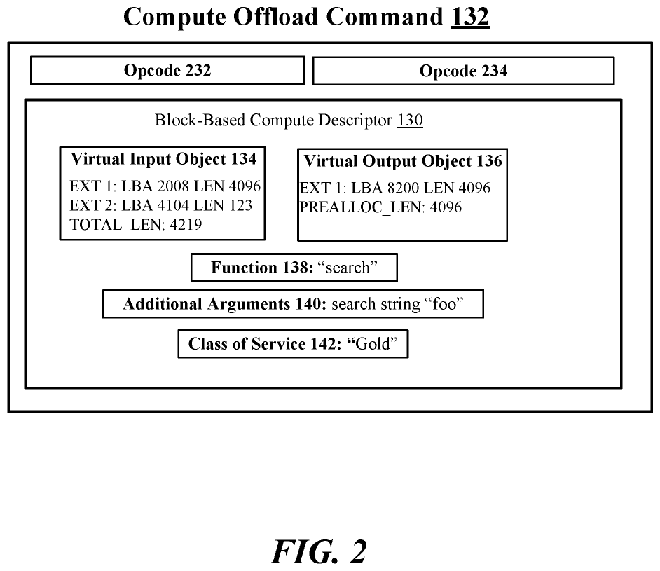

FIG. 2 illustrates an example compute offload command 132. In some examples, compute offload command can be arranged as a fused non-volatile command that includes a first opcode 232 and a second opcode 234. For these examples, opcode 232 can include information to facilitate transport of compute offload command 132 from host 102 to target 104 via communication link 119 and opcode 234 can include information to facilitate transport of a result of the compute offload request indicated in block-based compute descriptor 130 back to host 102. In other words, the two opcodes of compute offload command 132 result in a single I/O command.

In some examples, as shown in both FIG. 1 and FIG. 2, compute offload command 132 includes block-based compute descriptor 130. Example information included in virtual input object 134, virtual output object 136, function 138, additional arguments 140 and class of service 142 is shown in FIG. 2. For example, virtual input object 134 includes example information to indicate LBA addresses for two different block extents, a length of each block extent and a total length to represent a file size, which may or may not be an integral number of blocks. Virtual output object 136 includes example information to indicate an LBA address for a single block extent and information to indicate a pre-allocated numbers of block storage allocated by the host file system for storing results of a requested compute operation. function 138 includes example information to indicate that the requested compute operation is a search operation. Additional arguments 140 includes example information to indicate a search string of “foo”. Class of service 142 includes example information to indicate a gold class of service.

According to some examples, the gold class of service indicated in class of service 142 can be based on a tiered class of service scheme that can include, but is not limited to four hierarchical tiers. For example, the four hierarchical tiers can include a platinum, a gold, a silver or a bronze class of service, where platinum is the highest tier and bronze is the lowest tier class of service. In some examples, a platinum class of service indicates a highest priority for compute offload commands to be routed through NW interface 121 of target 104 and a gold class of service indicates a second highest priority, a silver class of service indicates a third highest priority, and a bronze class of service indicates a fourth highest/overall lowest priority. This tiered class of service scheme can also be used to implement one or more policies that can allow, for example, an independent software vendor (ISV) to specify a maximum or a limit to computational storage operations per second caused by compute offload commands sent to target 104. For example, a platinum class of service would allow for a highest limit and a bronze class of service would allow for a lowest limit to computational storage operations per second.

In some examples, compute offload command 132 can be formatted as a SCSI command transported over a network using an iSCSI transport protocol. For these examples, a SCSI command transported over a network using an iSCSI transport protocol can be referred to as an iSCSI command. Compute offload command 132 can be an iSCSI command that can use operation codes designated as (0x99). The use of (0x99) operation codes for a iSCSI command can be defined as a bi-directional command that can include an output buffer and an input buffer. The output buffer of the (0x99) iSCSI command (e.g., included in opcode 232) can be used to contain all the elements of block-based compute descriptor 130 except virtual output object 136 and the input buffer of the (0x99) iSCSI command (e.g., included in opcode 234) can be used to contain a result performed in response to an operation described in block-based compute descriptor 130 at the address indicted in virtual output object 136. In some examples, the (0x99) iSCSI command may be defined as a vendor-specific command, and/or may be referred to as an EXEC command. It should be understood that the (0x99) iSCSI command is mentioned for purposes of illustrating an example, and that any suitable opcode designation or other compute offload command identifier may be used in various examples.

According to some examples, compute offload command 132 can be formatted as one or more NVMe commands. For example, compute offload command 132 can be formatted as a fused NVMe command that includes two vendor-specific opcodes. The first vendor-specific opcode (e.g., included in opcode 232) can be referred to as (0x99) and/or can be referred to as an NVMe EXEC_WRITE command. The second vendor-specific opcode (e.g., included in opcode 234) can be referred to as (0x9a) and/or can be referred to as an NVMe EXEC_READ command. The NVMe EXEC_WRITE command can be equivalent to a first phase of the iSCSI bi-directional EXEC command discussed above (e.g., contain all the elements of block-based compute descriptor 130 except virtual output object 136) and/or the EXEC_READ command can be equivalent to a second phase of the iSCSI bi-directional EXEC command, discussed above (e.g., returns the result of the operation). In some examples, the fused NVMe command can be sent over a network using a NVMe-oF transport protocol. In some examples, an NVMe command transported over a network using a NVMe-oF transport protocol can be referred to as a NVMe-oF command. In some examples, an iSCSI or SCSI compute offload command (e.g., EXEC) may be translated to the fused NVMe command discussed above before sending to non-volatile memory (e.g., non-volatile memory 120 at target 104). It should be understood that the (0x99) and (0x9a) vendor-specific opcodes are mentioned for purposes of illustrating an example, and that any suitable opcode designation(s) or other compute offload command identifier(s) may be used in various examples involving other types of fabric transport technologies or protocols.

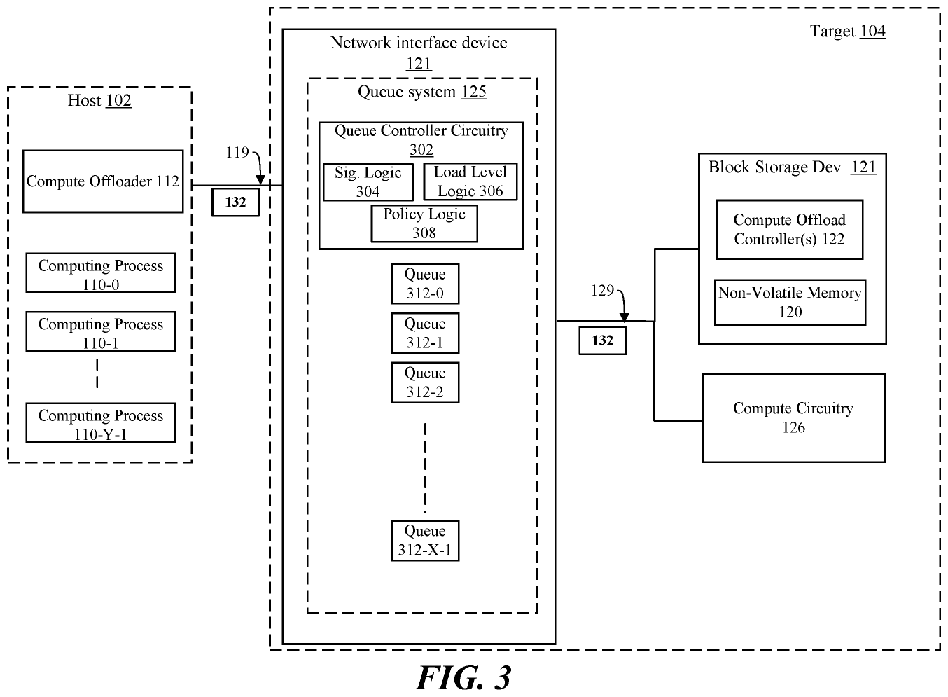

FIG. 3 illustrates an example of elements of queue system 125 for use in system 100 that includes host 102 and target 104. In some examples, as shown in FIG. 3, queue system 125 includes queue controller circuitry 302 and a memory 510 that is arranged to maintain a plurality of queues 312-0 to 312-X-1. In some examples, computing processes 110-0 to 110-Y-1 can generate compute offload requests that are then formatted in a compute offload command 132 that is forward to NW interface device 121 over communication link 119, X and Y are integers. Also, as shown in FIG. 3, queue controller circuitry 302 includes a signature logic 304, a load level logic 306 and a policy logic 308.

According to some examples, queue controller circuitry 302 includes logic and/or features such as signature logic 304 that can identify a class of service indicated in a block-based descriptor included in compute offload command 132 received over communication link 119 and then cause compute offload command 132 to be assigned to an appropriate queue from among queues 312-0 to 312-X-1. For these examples, inclusion of the class of service in block-based compute descriptor 130 can create a signature for compute offload command 132 via which signature logic 304 can determine which queue from among queues 312-0 to 312-X is to at least temporarily store content included in compute offload command 132 to facilitate a scheduling of a block-based compute operation associated with a compute offload request included in compute offload command 132 to block storage device 122 and/or compute circuitry 126. The determination of which queue, for example, can be based on one or more queues with a same identifier (e.g., same NAPI_ID) being assigned to the class of service indicated in the block-based descriptor included in compute offload command 132. The determined queue, for example, can also be referred to as a device queue (e.g., an Ethernet device queue) that stores content associated with the scheduled block-based compute operation to be sent to block storage device 122 and/or compute circuitry 126 via communication link 129.

In some examples, load level logic 306 of queue controller circuitry 302 can balance load levels amongst queues 312-1 to 312-X-1 assigned to a respective class of service. For example, an arbitration scheme (e.g., weighted round robin) can be implemented by load level logic 306 to prevent a computing process from among computing processes 110-0 to 110-Y-1 from dominating use of queues allocated to a given class of service at the expense of one or more other computing processes that also have the same class of service.

According to some examples, policy logic 308 of queue controller circuitry 302 can be arranged to enforce a policy associated with each class of service. For example, the policy can set a maximum or limit computational storage operations per second caused by received compute offload commands sent from host 102 and/or other host compute devices coupled with target 104. Policy logic 308, for example, can temporarily block queue allocation for a compute offload command if a computational storage operation for the class of service is expected to be reached or exceeded due to the compute offload command and then release the block once computational storage operations per second are expected to fall below the computational storage operation limit.

In some examples, computing processes 110-0 to 110-Y-1 can represent a service, microservice, cloud native microservice, workload, or software. Computing processes 110-0 to 110-Y-1 can represent execution of multiple threads of a same application. Computing processes 110-0 to 110-Y-1 can represent execution of multiple threads of different applications. Computing processes 110-0 to 110-Y-1 can represent one or more devices, such as a FPGA, an accelerator, or processor hosted by host 102. In some examples, any application or device can perform packet processing workloads and at least a portion of these packet processing workloads may be offloaded via a block-based compute operation to be executed by block storage device 122 and/or compute circuitry 126 responsive to a compute offload command such as compute offload command 132. Packet processing workloads can be based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group. A virtual network function (VNF) can include a service chain or sequence of virtualized tasks executed on generic configurable hardware such as firewalls, domain name system (DNS), caching or network address translation (NAT) and can run in VEEs. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure. Some applications can perform video processing or media transcoding (e.g., changing the encoding of audio, image or video files) workloads and at least a portion of these video processing or media transcoding workloads can be offloaded via a blocked-based compute operation to be executed by block storage device 122 and/or compute circuitry 126 responsive to a compute offload command such as compute offload command 132.

Although examples are provided with respect to a network interface device, other devices that can be used instead or in addition, include a fabric interface, a processor, and/or an accelerator device.

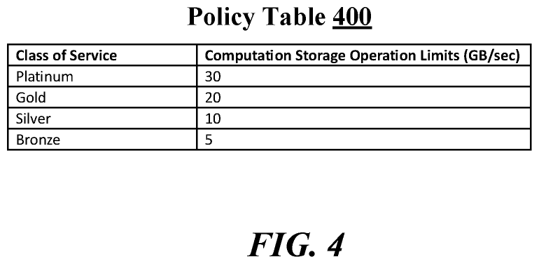

FIG. 4 illustrates an example policy table 400. In some examples, policy table 400 shows an example set of hierarchically tiered classes of service having assigned computational storage operation limits in gigabytes per second (GB/s). Examples are not limited to the four tiers shown in FIG. 4. Any number of tiers of 2 or greater are contemplated. For these examples, as shown in FIG. 1, the platinum class of service can have a computational storage operation limit of 30 GB/s, the gold class of service can have a computational storage operation limit of 20 GB/s, the silver class of service can have a computational storage operation limit of 10 GB/s and the bronze class of service can have a computational storage operation limit of 5 GB/s. Examples are not limited to 30, 20, 10 or 5 GB/s. In some examples, logic and/or features of queue controller circuitry of a queues system at a network interface device such as policy logic 308 of queue controller circuitry 302 can be configured to enforce a policy associated with policy table 400 to limit or restrict queue access of a compute offload request if that compute offload request has an indicated class of service that has reached or is expected to reach its respective limit if the compute offload request is sent.

Included below are process flows that can be representative of example methodologies for performing novel aspects for generating and sending a compute offload command to a computational storage server or receiving a compute offload command at a computational storage server to schedule a block-based compute operation for execution by compute circuitry at the computational storage server. While, for purposes of simplicity of explanation, the one or more methodologies shown herein are shown and described as a series of acts, those skilled in the art will understand and appreciate that the methodologies are not limited by the order of acts. Some acts can, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology can be required for a novel implementation.

A process flow can be implemented in software, firmware, and/or hardware. In software and firmware embodiments, a logic flow can be implemented by computer executable instructions stored on at least one non-transitory computer readable medium or machine readable medium, such as an optical, magnetic or semiconductor storage. The embodiments are not limited in this context.

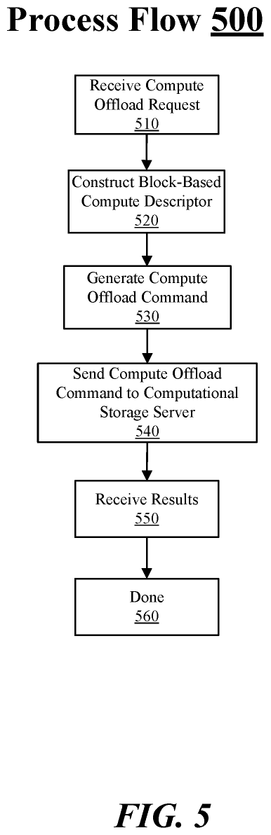

FIG. 5 illustrates an example process flow 500. In some examples, process flow 500 is an example process flow for generating and sending a compute offload command to a computational storage server such as described above for elements of host 102 shown in FIG. 1 or 3 such as circuitry logic and/or features compute offloader 112 and NW interface device 117 or elements of target 104 such as NW interface 121, block storage device 122 or compute circuitry 126. However, example process flow 500 is not limited to implementations using elements of host 102 or target 104 shown in FIG. 1 or 3 and/or mentioned above.

According to some examples, at 510, a compute offload request is received. For these examples, the compute offload request can be received by logic and/or features of compute offloader 112 from a computing process hosted by host 102 (e.g., from among computing processes 110).

In some examples, at 510, a block-based compute descriptor is constructed. For these examples, logic and/or features of compute offloader 112 (e.g., client offload circuitry 114) can construct the block-based compute descriptor responsive to the received compute offload request. The block-based compute descriptor can be in the example format of block-based compute descriptor 130 shown in FIG. 1 or FIG. 2 and includes an indication of a class of service associated with the compute offload request.

According to some examples, at 530, a compute offload command is generated. For these examples, the compute offload command can be in the example format of compute offload command 132 as shown in FIG. 2 that serves as a fused non-volatile memory command that includes first and second opcodes. The first opcode, for example, can provide for or facilitate a transfer of the block-based compute descriptor included in the compute offload command. The second opcode, for example, can provide for or facilitate a transfer of a result of the compute offload request back to host 102 from target 104.

In some examples, at 540, the compute offload command is sent to a computational storage server. For these examples, the computational storage server is target 104 and the compute offload command is sent over communication link 119 coupled between host 102 and target 104. The indication of class of service in the block-based compute descriptor can cause a network interface device 121 at target 104 to store the compute offload command to a queue (e.g., from among queues 312-1 to 312-X-1) allocated to the class of service. The queue can be arranged to store the compute offload command prior to scheduling a block-based compute operation by compute circuitry 126 at target 104. The block-based compute operation can include use of non-volatile memory 120 included in block storage device 122 (e.g., to retrieve inputs and to store outputs for the block-based compute operation).

According to some examples, at 550, results are received. For these examples, results associated with the compute offload request can be returned by target 104 based on the second opcode included in the compute offload command that was sent to target 104.

In some examples, at 560, process flow 500 is done. Process flow 500 can start again at 510 responsive to receiving another compute offload request.

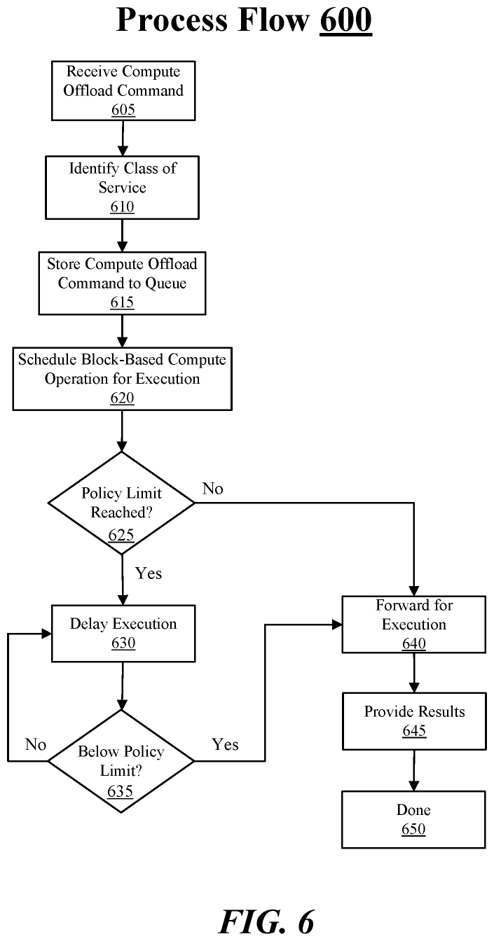

FIG. 6 illustrates an example process flow 600. In some examples, process flow 600 is an example process flow for receiving a compute offload command at a computational storage server to schedule a block-based compute operation for execution by compute circuitry at the computational storage server such as described above for elements of host 102 shown in FIG. 1 or 3 such as circuitry logic and/or features compute offloader 112 and NW interface device 117 or elements of target 104 such as NW interface device 121, block storage device 122 or compute circuitry 126. Also elements of NW interface device 121 such as queue controller circuitry 302 of queue system 125 or queues 312 maintained in memory 510 and elements of block storage device 122 such as compute offload controller(s) 122 or non-volatile memory 120 can implement or can be associated with at least portions of process flow 600 However, example process flow 500 is not limited to implementations using these elements of host 102 or target 104 shown in FIG. 1 or 3 and/or mentioned above.

According to some examples, at 605, a compute offload command is received. For these examples, the compute offload command can be received by NW interface device 121 at target 104 from host 102 via communication link 119. Similar to what was described above for process 500, the compute offload command can be in the example format of compute offload command 132 and serves as a fused non-volatile memory command that includes first and second opcodes. The first opcode, for example, can provide for or facilitate a transfer of the block-based compute descriptor included in the compute offload command. The block-based compute descriptor can be constructed based on a compute offload request from a computing process hosted by host 102 (e.g., from among computing processes 110). The second opcode, for example, can provide for or facilitate a transfer of a result of the compute offload request back to host 102 from target 104.

In some examples, at 610, a class of service indicated in the block-based compute descriptor included in the received compute offload command is identified. For these examples, logic and/or features of queue controller circuitry 302 of queue system 125 at NW interface device 121 can be configured to identify the class of service. For example, signature logic 302 can be configured to identify the class of service.

According to some examples, at 615, the compute offload command is stored to a queue. For these examples, queue controller circuitry 302 of queue system 125 at NW interface device 121 can be configured to store the compute offload command to a queue from among queues 312 maintained in memory 510. The queue to be previously allocated to the identified class of service. Also, the block-based compute descriptor included in the compute offload command can include information to be used for execution of the block-based compute operation by compute circuitry 126 at target 104.

In some examples, at 620, the block-based compute operation is scheduled for execution by compute circuitry 126. For these examples, logic and/or features of queue controller circuitry 302 such as load level logic 306 can schedule the block-based compute operation for execution.

According to some examples, at 625, logic and/or features of queue controller circuitry 302 such as policy logic 308 can determine whether a policy limit has been reached. For these examples, the policy limit can be similar to the limits shown in FIG. 4 for policy table 400. If the class of service was identified as a gold class of server, for example, policy logic 308 can be configured to determine whether the block-based compute operation would cause computational storage operation limits to be reached or exceeded. If the policy limit is exceeded, process flow 600 moves to 630. Otherwise, process flow 600 moves to 640.

In some examples, at 630, execution of the block-based compute operation is delayed for a period of time.

According to some examples, at 635, policy logic 308 can reassess whether delaying the block-based compute operation results in the expected computational storage operations/sec to fall below the policy limit. If below the policy limit, process flow 600 moves to 645. Otherwise, process flow 600 moves back to 630.

In some examples, at 640, the scheduled block-based compute operation is allowed to be forwarded to compute circuitry 126 for execution.

According to some examples, at 645, results of the block-based compute operations are provided to host 102. For these examples, results can be returned to host 102 based on the second opcode included in the compute offload command that was received at 605.

In some examples, at 650, process flow 600 is done. Process flow 600 can start again at 605 responsive to receiving another compute offload command from compute device or compute server.

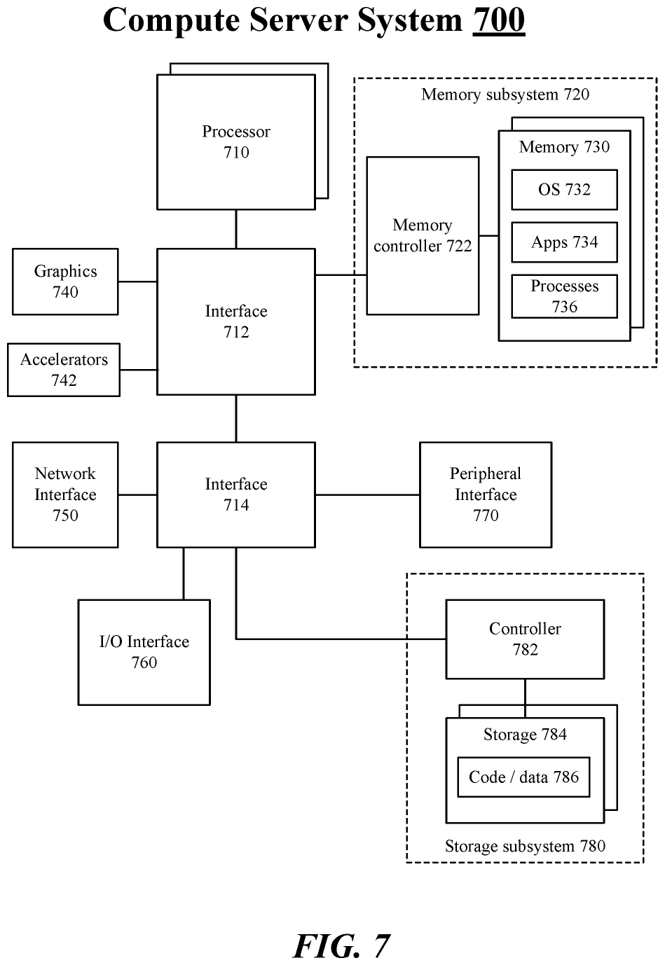

FIG. 7 illustrates an example compute server system 700. In some examples, operation of processors 710 and/or network interface 750 can be configured generate and send compute offload commands responsive to compute offload requests received from computing processes supported by processors 710. The compute offload requests for computational storage operations at a targeted computational storage server can be associated with a class of service that can be indicated in the compute offload commands, as described herein. Processor 710 can include any type of microprocessor, central processing unit (CPU), graphics processing unit (GPU), XPU, processing core, or other processing hardware to provide processing for compute server system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of compute server system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, compute server system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of compute server system 700. In one example, graphics interface 740 can drive a display that provides an output to a user. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, ASICs, neural network processors (NNPs), programmable control logic, and programmable processing elements such as FPGAs. Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of compute server system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in compute server system 700. Additionally, applications 734 can execute on the software platform of OS 732 from memory 730. Applications 734 represent programs that have their own operational logic to perform execution of one or more functions. In some examples, one or more applications included in applications 734 may be referred to as a computing process. Processes 736 represent agents or routines that provide auxiliary functions to OS 732 or one or more applications 734 or a combination. OS 732, applications 734, and processes 736 provide software logic to provide functions for compute server system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

Applications 734 and/or processes 736 can refer instead or additionally to a virtual machine (VM), container, microservice, processor, or other software. Various examples described herein can perform an application composed of microservices.

A virtualized execution environment (VEE) can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from one another, allowing virtual machines to run Linux®, Windows® Server, VMware ESXi, and other operating systems on the same underlying physical host. In some examples, an operating system can issue a configuration to a data plane of network interface 750.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers may be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others. In some examples, OS 732 or driver can configure a load balancer and a queue system for load balancing traffic and/or processing memcached requests or remote procedure calls, as described herein.

While not specifically illustrated, it will be understood that compute server system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a PCI or PCIe bus, a Hyper Transport or industry standard architecture (ISA) bus, a SCSI bus, a universal serial bus (USB), or an Institute of Electrical and Electronics Engineers (IEEE) standard 1394 bus (Firewire).

In one example, compute server system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides compute server system 700 with the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. In some examples, network interface 750 or network interface device 750 can refer to one or more of: a network interface controller (NIC), a remote direct memory access (RDMA)-enabled NIC, SmartNIC, router, switch (e.g., top of rack (ToR) or end of row (EoR)), forwarding element, infrastructure processing unit (IPU), or data processing unit (DPU).

In one example, compute server system 700 includes one or more I/O interface(s) 760. Peripheral interface 770 can include any hardware interface not specifically mentioned above. Peripherals refer generally to devices that connect dependently to compute server system 700. A dependent connection is one where compute server system 700 provides the software platform or hardware platform or both on which operation executes, and with which a user interacts.

In one example, compute server system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to compute server system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to compute server system 700). In one example, storage subsystem 780 includes controller 782 to interface with storage 784. In one example controller 782 is a physical part of interface 714 or processor 710 or can include circuits or logic in both processor 710 and interface 714. A volatile memory is memory whose state (and therefore the data stored in it) is indeterminate if power is interrupted to the device. A non-volatile memory device is a memory whose state is determinate even if power is interrupted to the device.

In an example, compute server system 700 can be implemented using interconnected compute nodes of processors, memories, storages, network interfaces, and other components. High speed interconnects can be used and can be operated according to various technologies or protocols such as, but not limited to: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using fabric transport protocols such as NVMe-oF or NVMe.

Communications between devices can take place using a network that provides die-to-die communications; chip-to-chip communications; chiplet-to-chiplet communications; circuit board-to-circuit board communications; and/or package-to-package communications. A die-to-die communications can utilize Embedded Multi-Die Interconnect Bridge (EMIB) or an interposer.

In an example, compute server system 700 can be implemented using interconnected compute platforms that include processors, memories, storages, network interfaces, or other components. High speed interconnects can be used such as, but not limited to, CXL, PCIe, Ethernet, or optical interconnects (or a combination thereof).

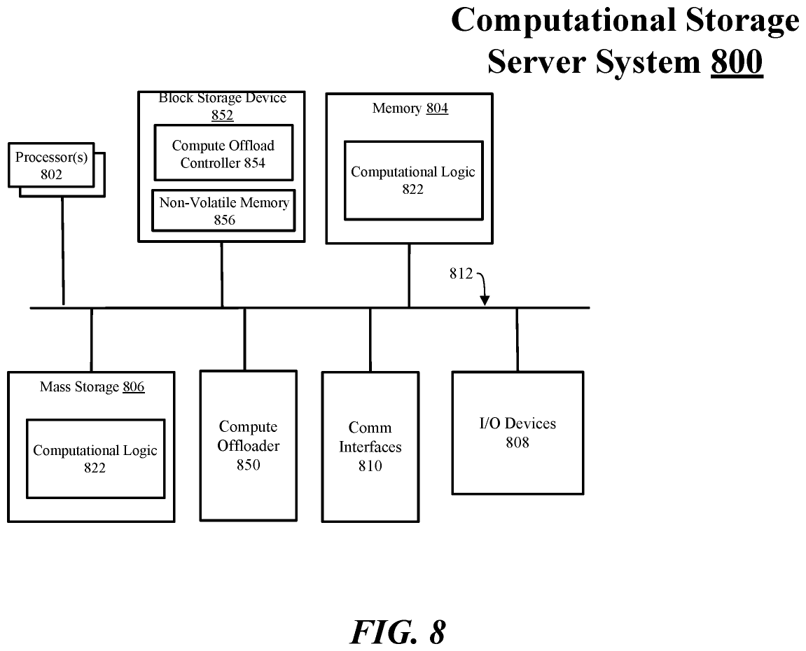

FIG. 8 illustrates an computational storage server system 800. In some examples, computational storage server system 800 can be suitable with components of target 104 shown in FIGS. 1 and 3 and mentioned in process flow 500.

In some examples, as shown in FIG. 8, computational storage server system 800 can include one or more processors or processor cores 802 and system memory 804. Processor(s) 802 can include any type of processor or computing device, such as, but not limited to, a central processing unit (CPU), a microprocessor, an accelerator, a GPU, an IPU or a DPU. In one example, processor(s) 802 can be implemented as one or more integrated circuits each having multi-cores, e.g., a multi-core microprocessor or multi-socket, multi-core microprocessors. For these examples, processor(s) 802, in addition to cores, may further include hardware accelerators, e.g., hardware accelerators implemented with one or more FPGAs or one or more ASICs. Computational storage server system 800 can include mass storage devices 806 (such as diskette, hard drive, non-volatile memory) (e.g., compact disc read-only memory (CD-ROM), digital versatile disk (DVD), any other type of suitable non-volatile memory and so forth). In general, system memory 804 and/or mass storage devices 806 can be temporal and/or persistent storage of any type, including, but not limited to, volatile and non-volatile memory, optical, magnetic, and/or solid state mass storage, and so forth. Volatile memory may include, but is not limited to, DRAM. Non-volatile memory may include, but is not limited to, electrically erasable programmable read-only memory, phase change memory, resistive memory, NAND memory and so forth. In some embodiments, the mass storage devices 806 may include non-volatile memory 120 of target 104 as described with respect to FIG. 1.

Computational storage server system 800 can further include I/O devices 808 (such as a display (e.g., a touchscreen display), keyboard, cursor control, remote control, gaming controller, image capture device, and so forth) and communication interfaces 810 (such as network interface cards, modems, infrared receivers, radio receivers (e.g., Bluetooth), and so forth), one or more antennas, and/or any other suitable component.

Communication interfaces 810 can include communication chips (not shown for clarity) that may be configured to operate the computational storage server system 800 in accordance with a local area network (LAN) (e.g., Ethernet). Communication interfaces 810 can also be configured to couple with high speed interconnects to be operated according to various technologies or protocols such as, but not limited to: Ethernet (IEEE 802.3), RDMA, iWARP, TCP, UDP, QUIC, RoCE, PCIe, Intel® QPI, Intel® UPI, Intel® IOSF, Omni-Path, CXL, HyperTransport, high-speed fabric, NVIDIA® NVLink, AMBA interconnect, OpenCAPI, Gen-Z, IF, CCIX, 3GPP Long Term Evolution (LTE) (4G), 3GPP 5G, and variations thereof. Data can be copied or stored to virtualized storage nodes or accessed using fabric transport protocols such as NVMe-oF or NVMe.

In some examples, computational storage server system 800 can include a block storage device 852 that can include a compute offload controller 854 and/or a non-volatile memory 856. In some examples, block storage device 852 or components thereof can be coupled with other components of computational storage server system 800. Block storage device 852 can include a different number of components (e.g., non-volatile memory 856 may be located in mass storage 806) or can include additional components of computational storage server system 800 (e.g., processor(s) 802 and/or memory 804 may be a part of block storage device 852). In some examples, compute offload controller 854 can be configured in a similar fashion to the compute offload controller 122 of target 104 as described with respect to FIG. 1.

According to some examples, computational storage server system 800 can include a compute offloader 850. For these examples, compute offloader 850 can be configured in a similar fashion to compute offloader 112 of target 104 as described with respect to FIG. 1. In some examples, computational storage server system 800 can include both compute offloader 850 and block storage device 852 (e.g., as part of a pool of SSDs), and the compute offloader 850 can send compute offload commands (e.g., NVMe or SCSI) that contain a block-based compute descriptor to block storage device 852 over a local bus. In other examples, a first computational storage server system 800 can include compute offloader 850, a second computational storage server system 800 can include block storage device 852, and compute offloader 850 can send compute offload commands (e.g., iSCSI or NVMe-oF) to block storage device 852 over a network (e.g., via communications interfaces 810). The first computational storage server system 800 and the second computational storage server system 800 may be components of a disaggregated computing environment, where the second computational storage server system 800 with the block storage device 852 is a storage server that can include a compute-in-storage capability provided by block storage device 852.

The above-described computational storage server system 800 elements can be coupled to each other via system bus 812, which may represent one or more buses. In the case of multiple buses, they may be bridged by one or more bus bridges (not shown). Each of these elements may perform its conventional functions known in the art. In particular, system memory 804 and mass storage devices 806 can be employed to store a working copy and a permanent copy of the programming instructions for the operation of various components of computational storage server system 800, including but not limited to an operating system of computational storage server system 800, one or more applications, operations associated with computational storage server system 800, operations associated with the block storage device 852, and/or operations associated with the compute offloader 850, collectively denoted as computational logic 822. The various elements may be implemented by assembler instructions supported by processor(s) 802 or high-level languages that may be compiled into such instructions. In some embodiments, computational storage server system 800 may be implemented as a fixed function ASIC, an FPGA, or any other suitable device with or without programmability or configuration options.

The permanent copy of the programming instructions may be placed into mass storage devices 806 in the factory, or in the field through, for example, a distribution medium (not shown), such as a compact disc (CD), or through communication interface 810 (from a distribution server (not shown)). That is, one or more distribution media having an implementation of the agent program may be employed to distribute the agent and to program various computing devices.

In some examples, at least one of processor(s) 802 can be packaged together with computational logic 822 configured to practice aspects of examples described herein to form a System in Package (SiP) or a System on Chip (SoC).

Although apparatus 800 shown in FIG. 8 has a limited number of elements in a certain topology, it can be appreciated that the apparatus 800 can include more or less elements in alternate topologies as desired for a given implementation.

One or more aspects of at least one example can be implemented by representative instructions stored on at least one machine-readable medium which represents various logic within the processor, which when read by a machine, computing device or system causes the machine, computing device or system to fabricate logic to perform the techniques described herein. Such representations, known as “IP cores” can be stored on a tangible, machine readable medium and supplied to various customers or manufacturing facilities to load into the fabrication machines that actually make the logic or processor.

Various examples can be implemented using hardware elements, software elements, or a combination of both. In some examples, hardware elements can include devices, components, processors, microprocessors, circuits, circuit elements (e.g., transistors, resistors, capacitors, inductors, and so forth), integrated circuits, processors, accelerators, GPUs, ASICs, PLDs, DSPs, FPGAs, memory units, logic gates, registers, semiconductor device, chips, microchips, chip sets, and so forth. In some examples, software elements can include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements can vary in accordance with any number of factors, such as desired computational rate, power levels, heat tolerances, processing cycle budget, input data rates, output data rates, memory resources, data bus speeds and other design or performance constraints, as desired for a given implementation.

Some examples can include an article of manufacture or at least one computer-readable medium. A computer-readable medium can include a non-transitory storage medium to store logic. In some examples, the non-transitory storage medium can include one or more types of computer-readable storage media capable of storing electronic data, including volatile memory or non-volatile memory, removable or non-removable memory, erasable or non-erasable memory, writeable or re-writeable memory, and so forth. In some examples, the logic can include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium can include a non-transitory storage medium to store or maintain instructions that when executed by a machine, computing device or system, cause the machine, computing device or system to perform methods and/or operations in accordance with the described examples. The instructions can include any suitable type of code, such as source code, compiled code, interpreted code, executable code, static code, dynamic code, and the like. The instructions can be implemented according to a predefined computer language, manner or syntax, for instructing a machine, computing device or system to perform a certain function. The instructions can be implemented using any suitable high-level, low-level, object-oriented, visual, compiled and/or interpreted programming language.

Some examples can be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples can be described using the expression “coupled” and “connected” along with their derivatives. These terms are not necessarily intended as synonyms for each other. For example, descriptions using the terms “connected” and/or “coupled” can indicate that two or more elements are in direct physical or electrical contact with each other. The term “coupled” or “coupled with”, however, can also mean that two or more elements are not in direct contact with each other, but yet still co-operate or interact with each other.

The following examples pertain to additional examples of technologies disclosed herein.

Example 1. An example network interface device at a computational storage server can include a memory arranged to include a plurality of queues and circuitry. The circuitry can be configured to receive, from a compute device over a network link, a compute offload command that is arranged as a fused non-volatile memory command that includes first and second opcodes. The compute offload command can have a block-based compute descriptor that was constructed based on a compute offload request from a computing process hosted by a compute device. The circuitry can also be configured to identify a class of service indicated in the block-based compute descriptor and store the compute offload command to a queue from among the plurality of queues. The queue could have been previously allocated to the class of service. The block-based compute descriptor included in the compute offload command can include information to be used for execution of a block-based compute operation by compute circuitry at the computational storage server.

Example 2. The network interface device of example 1, the compute offload command can be stored to the queue allocated to the class of service in order to shape network traffic associated with compute offload commands received over the network link.

Example 3. The network interface device of example 1, the class of service can be one class of service among a plurality of class of services based on a priority scheme that allocates more queues to a first class of service assigned a higher priority compared to a second class of service assigned a lower priority.

Example 4. The network interface device of example 1, the block-based compute operation can be against virtual objects in a block storage device at the computational storage server, the block storage device to include non-volatile memory.

Example 5. The network interface device of example 4, the block-based compute descriptor can include storage blocks mapped to the virtual objects of example 4. For this example, a first group of one or more storage blocks can be arranged to be an input for the block-based compute operation and a second group of one or more storage blocks can be arranged to be an output for the block-based compute operation.

Example 6. The network interface device of example 1, the information to be used for execution of the block-based compute operation can indicate a function associated with the compute offload request received from the computing process hosted by the compute device. For this example, the function can be a compression compute operation, a checksum compute operation, a searching compute operation, an image resizing compute operation, a word count compute operation, a video transcoding compute operation, a sorting compute operation, a merging compute operation, a filtering compute operation, a hashing compute operation or a de-duplication compute operation.

Example 7. The network interface device of example 1, the first opcode included in the fused non-volatile memory command can be configured to provide a transfer of the compute offload command from the compute device to the computational storage server, and the second opcode included in the fused non-volatile memory command can be configured to provide a transfer, to the computing device, of a result of the compute offload request from the computing process.

Example 8. The network interface device of example 1, the compute offload command arranged as a fused non-volatile memory command can be based on an NVMe-oF transport protocol or an iSCSI transport protocol.

Example 9. An example method can include receiving, at a network interface at a computational storage server over a network link, a compute offload command from a compute device. The compute offload command can include first and second opcodes. The compute offload command can have a block-based compute descriptor that was constructed based on a compute offload request from a computing process hosted by a compute device. The method can also include identifying a class of service indicated in the block-based compute descriptor. The method can also include storing the compute offload command to a queue from among a plurality of queues maintained in a memory at the network interface, the queue previously allocated to the class of service. For this example, the block-based compute descriptor included in the compute offload command can include information to be used for execution of a block-based compute operation by compute circuitry at the computational storage server.

Example 10. The method of example 9, storing the compute offload command to the queue allocated to the class of service can shape network traffic associated with compute offload commands received over the network link.

Example 11. The method of example 9, the class of service can be one class of service among a plurality of class of services based on a priority scheme that allocates more queues to a first class of service assigned a higher priority compared to a second class of service assigned a lower priority.

Example 12. The method of example 9, the block-based compute operation can be against virtual objects in a block storage device at the computational storage server, the block storage device to include non-volatile memory.

Example 13. The method of example 12, the block-based compute descriptor can include storage blocks mapped to the virtual objects of example 12. For this example, a first group of one or more storage blocks can be arranged to be an input for the block-based compute operation and a second group of one or more storage blocks can be arranged to be an output for the block-based compute operation.

Example 14. The method of example 9, the information to be used for execution of the block-based compute operation can indicate a function associated with the compute offload request received from the computing process hosted by the compute device. For this example, the function is a compression compute operation, a checksum compute operation, a searching compute operation, an image resizing compute operation, a word count compute operation, a video transcoding compute operation, a sorting compute operation, a merging compute operation, a filtering compute operation, a hashing compute operation or a de-duplication compute operation.

Example 15. The method of example 9, the first opcode included in compute offload command can be configured to provide a transfer of the compute offload command from the compute device to the computational storage server, and the second opcode included in the compute offload command can be configured to provide a transfer, to the computing device, of a result of the compute offload request from the computing process.

Example 16. The method of example 9, the compute offload command arranged as a fused non-volatile memory command can be based on an NVMe-oF transport protocol or an iSCSI transport protocol.

Example 17. An example at least one machine readable medium can include a plurality of instructions that in response to being executed by a system can cause the system to carry out a method according to any one of examples 9 to 16.

Example 18. An example apparatus can include means for performing the methods of any one of examples 9 to 16.

Example 19. An example at least one machine readable medium can include a plurality of instructions that in response to being executed by circuitry at a network interface device at a computational storage server, can cause the circuitry to receive, from a compute device over a network link, a compute offload command that is arranged as a fused non-volatile memory command that includes first and second opcodes. The compute offload command can have a block-based compute descriptor that was constructed based on a compute offload request from a computing process hosted by a compute device. The instructions can also cause the circuitry to identify a class of service indicated in the block-based compute descriptor. The instructions can also cause the circuitry to cause the compute offload command to be stored to a queue from among a plurality of queues maintained in a memory at the network interface device, the queue previously allocated to the class of service. For this example, the block-based compute descriptor can be included in the compute offload command and can include information to be used for execution of a block-based compute operation by compute circuitry at the computational storage server.

Example 20. The at least one machine readable medium of example 19, to cause the compute offload command to be stored to the queue allocated to the class of service can be to shape network traffic associated with compute offload commands received over the network link.

Example 21. The at least one machine readable medium of example 19, wherein the class of service is one class of service among a plurality of class of services based on a priority scheme that allocates more queues to a first class of service assigned a higher priority compared to a second class of service assigned a lower priority.

Example 22. The at least one machine readable medium of example 19, the block-based compute operation can be against virtual objects in a block storage device at the computational storage server, the block storage device to include non-volatile memory.

Example 23. The at least one machine readable medium of example 22, the block-based compute descriptor can include storage blocks mapped to the virtual objects of example 22. For this example, a first group of one or more storage blocks is arranged to be an input for the block-based compute operation and a second group of one or more storage blocks is arranged to be an output for the block-based compute operation.

Example 24. The at least one machine readable medium of example 19, the information to be used for execution of the block-based compute operation can indicate a function associated with the compute offload request received from the computing process hosted by the compute device. For this example, the function can be a compression compute operation, a checksum compute operation, a searching compute operation, an image resizing compute operation, a word count compute operation, a video transcoding compute operation, a sorting compute operation, a merging compute operation, a filtering compute operation, a hashing compute operation or a de-duplication compute operation.

Example 25. The at least one machine readable medium of example 19, the first opcode included in the fused non-volatile memory command can be configured to provide a transfer of the compute offload command from the compute device to the computational storage server, and the second opcode included in the fused non-volatile memory command can be configured to provide a transfer, to the computing device, of a result of the compute offload request from the computing process.

Example 26. The at least one machine readable medium of example 19, the compute offload command arranged as a fused non-volatile memory command can be based on an NVMe-oF transport protocol or an iSCSI transport protocol.

Example 27. An example apparatus can include circuitry at a compute device. The circuitry can construct a block-based compute descriptor responsive to a compute offload request received from a computing process hosted by the compute device. The block-based compute descriptor can include an indication of a class of service associated with the compute offload request. The circuitry can also generate a compute offload command arranged as a fused non-volatile memory command that includes first and second opcodes. The circuitry can also send the compute offload command over a network link to a computational storage server. For this example, the indication of the class of service in the block-based compute descriptor can cause a network interface device at the computational storage server to store the compute offload command to a queue allocated to the class of service. The queue can store the compute offload command prior to scheduling a block-based compute operation by compute circuitry at the volatile memory maintained at the computational storage server.

Example 28. The apparatus of example 27, the compute offload command is to be stored to the queue allocated to the class of service in order to shape network traffic associated with compute offload commands sent to the computational storage server over the network link.

Example 29. The apparatus of example 27, the class of service can one class of service among a plurality of class of services based on a priority scheme that allocates more queues to a first class of service assigned a higher priority compared to a second class of service assigned a lower priority.

Example 30. The apparatus of example 27, the block-based compute descriptor can include information to be used for execution of the block-based compute operation by the compute circuitry at the computational storage server. For this example, the block-based compute operation is against virtual objects in the non-volatile memory.

Example 31. The apparatus of example 30, the block-based compute descriptor can include storage blocks mapped to the virtual objects of example 30. For this example, a first group of one or more storage blocks can be arranged to be an input for the block-based compute operation and second group of one or more storage blocks can be arranged to be an output for the block-based compute operation.

Example 32. The apparatus of example 30, the information to be used for execution of the block-based compute operation can indicate a function associated with the compute offload request received from the computing process hosted by the compute device. For this example, the function is a compression compute operation, a checksum compute operation, a searching compute operation, an image resizing compute operation, a word count compute operation, a operation, a filtering compute operation, a hashing compute operation or a de-duplication compute operation.

Example 33. The apparatus of example 27, the first opcode included in the fused non-volatile memory command can be arranged to provide a transfer of the block-based compute descriptor from the compute device to the computational storage server, and the second opcode included in the fused non-volatile memory command can be arranged to provide a transfer of a result of the compute offload request to the computing device from the computational storage server.

Example 34. The apparatus of example 27, the compute offload command arranged as a fused non-volatile memory command can be based on an NVMe-oF transport protocol or an iSCSI transport protocol.

Example 35. An example method can include constructing, at circuitry of a compute device, a block-based compute descriptor responsive to a compute offload request received from a computing process hosted by a host compute device. The block-based compute descriptor can include an indication of a class of service associated with the compute offload request. The method can also include, generating a compute offload command arranged as a fused non-volatile memory command that includes first and second opcodes. The method can also include sending the compute offload command over a network link to a computational storage server. For this example, the indication of the class of service in the block-based compute descriptor can cause a network interface device at the computational storage server to store the compute offload command to a queue allocated to the class of service. The queue can store the compute offload command prior to scheduling a block-based compute operation by compute circuitry at the volatile memory maintained at the computational storage server.

Example 36. The method of example 35, the compute offload command can be stored to the queue allocated to the class of service in order to shape network traffic associated with compute offload commands sent to the computational storage server over the network link.

Example 37. The method of example 35, the class of service can be one class of service among a plurality of class of services based on a priority scheme that allocates more queues to a first class of service assigned a higher priority compared to a second class of service assigned a lower priority.

Example 38. The method of example 35, the block-based compute descriptor can include information to be used for execution of the block-based compute operation by the compute circuitry at the computational storage server. For this example, the block-based compute operation is against virtual objects in the non-volatile memory.

Example 39. The method of example 38, the block-based compute descriptor can include storage blocks mapped to the virtual objects of example 38. For this example, a first group of one or more storage blocks can be arranged to be an input for the block-based compute operation and second group of one or more storage blocks can be arranged to be an output for the block-based compute operation.

Example 40. The method of example 38, the information used for execution of the block-based compute operation can indicate a function associated with the compute offload request received from the computing process hosted by the compute device. For this example, the function can be a compression compute operation, a checksum compute operation, a searching compute operation, an image resizing compute operation, a word count compute operation, a video transcoding compute operation, a sorting compute operation, a merging compute operation, a filtering compute operation, a hashing compute operation or a de-duplication compute operation.

Example 41. The method of example 35, the first opcode included in the fused non-volatile memory command can be arranged to provide a transfer of the block-based compute descriptor from the compute device to the computational storage server, and the second opcode included in the fused non-volatile memory command can be arranged to provide a transfer of a result of the compute offload request to the computing device from the computational storage server.

Example 42. The method of example 35, the compute offload command arranged as a fused non-volatile memory command can be based on an NVMe-oF transport protocol or an iSCSI transport protocol.

Example 43. An example at least one machine readable medium can include a plurality of instructions that in response to being executed by a system causes the system to carry out a method according to any one of examples 35 to 42.

Example 44. An example apparatus can include means for performing the methods of any one of examples 35 to 43.

Example 45. An example at least one machine readable medium can include a plurality of instructions that in response to being executed by circuitry of a computing device cause the circuitry to construct a block-based compute descriptor responsive to a compute offload request received from a computing process hosted by a host compute device. The block-based compute descriptor can include an indication of a class of service associated with the compute offload request. The instructions can also cause the circuitry to generate a compute offload command arranged as a fused non-volatile memory command that includes first and second opcodes. The instructions can also cause the circuitry to cause the compute offload command to be sent over a network link to a computational storage server. For this example, the indication of the class of service in the block-based compute descriptor can cause a network interface device at the computational storage server to store the compute offload command to a queue allocated to the class of service. The queue can store the compute offload command prior to scheduling a block-based compute operation by compute circuitry at the computational storage server. The block-based compute operation can include use of non-volatile memory maintained at the computational storage server.

Example 46. The at least one machine readable medium of example 45, the compute offload command can be stored to the queue allocated to the class of service in order to shape network traffic associated with compute offload commands sent to the computational storage server over the network link.

Example 47. The at least one machine readable medium of example 45, the class of service can be one class of service among a plurality of class of services based on a priority scheme that allocates more queues to a first class of service assigned a higher priority compared to a second class of service assigned a lower priority.

Example 48. The at least one machine readable medium of example 45, the block-based compute descriptor can include information to be used for execution of the block-based compute operation by the compute circuitry at the computational storage server. For this example, the scheduled block-based compute operation can be against virtual objects in the non-volatile memory.

Example 49. The at least one machine readable medium of example 48, the block-based compute descriptor can include storage blocks mapped to the virtual objects of example 48. For this example, a first group of one or more storage blocks can be arranged to be an input for the block-based compute operation and second group of one or more storage blocks can be arranged to be an output for the block-based compute operation.

Example 50. The at least one machine readable medium of example 48, the information to be used for execution of the block-based compute operation can indicate a function associated with the compute offload request received from the computing process hosted by the compute device. For this example the function can be a compression compute operation, a checksum compute operation, a searching compute operation, an image resizing compute operation, a word count compute operation, a video transcoding compute operation, a sorting compute operation, a merging compute operation, a filtering compute operation, a hashing compute operation or a de-duplication compute operation.

Example 51. The at least one machine readable medium of example 45, the first opcode included in the fused non-volatile memory command can be arranged to provide a transfer of the block-based compute descriptor from the compute device to the computational storage server, and the second opcode included in the fused non-volatile memory command can be arranged to provide a transfer of a result of the compute offload request to the computing device from the computational storage server.

Example 52. The at least one machine readable medium of example 45, the compute offload command arranged as a fused non-volatile memory command can be based on an NVMe-oF transport protocol or an iSCSI transport protocol.

Example 53. An example system can include a block storage device to include non-volatile memory, compute circuitry, and a network interface device. The network interface device can include circuitry and a memory arranged to maintain a plurality of queues. The circuitry of the network interface device can be configured to receive, from a compute device over a network link, a compute offload command that is arranged as a fused non-volatile memory command that includes first and second opcodes. The compute offload command can have a block-based compute descriptor that was constructed based on a compute offload request from a computing process hosted by a compute device. The circuitry of the network interface device can also be configured to identify a class of service indicated in the block-based compute descriptor. The circuitry of the network interface device can also be configured to store the compute offload command to a queue from among the plurality of queues, the queue previously allocated to the class of service. For this example, the block-based compute descriptor included in the compute offload command can include information to be used for execution of a block-based compute operation by the compute circuitry, the block-based compute operation to be against virtual objects in the non-volatile memory of the block storage device.

Example 54. The system of example 53, the compute offload command can be stored to the queue allocated to the class of service in order to shape network traffic associated with compute offload commands received over the network link.

Example 55. The system of example 53, wherein the class of service can be one class of service among a plurality of class of services based on a priority scheme that allocates more queues to a first class of service assigned a higher priority compared to a second class of service assigned a lower priority.

Example 56. The system of example 53, the block-based compute descriptor can include storage blocks maintained in the non-volatile memory that can be mapped to the virtual objects. For this example, a first group of one or more storage blocks can be arranged to be an input for the block-based compute operation and a second group of one or more storage blocks can be arranged to be an output for the block-based compute operation.

Example 57. The system of example 53, the information to be used for execution of the block-based compute operation can indicate a function associated with the compute offload request received from the computing process hosted by the compute device. For this example, the function can be a compression compute operation, a checksum compute operation, a searching compute operation, an image resizing compute operation, a word count compute operation, a video transcoding compute operation, a sorting compute operation, a merging compute operation, a filtering compute operation, a hashing compute operation or a de-duplication compute operation.

Example 58. The system of example 53, the first opcode included in the fused non-volatile memory command can be configured to provide a transfer of the compute offload command from the compute device to the network interface device, and the second opcode included in the fused non-volatile memory command can be configured to provide a transfer, to the computing device, of a result of the compute offload request from the computing process.

Example 59. The system of example 53, the compute offload command can be arranged as an NVMe-oF transport protocol or an iSCSI transport protocol.

It is emphasized that the Abstract of the Disclosure is provided to comply with 38 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A network interface device at a computational storage server comprising:
a memory arranged to include a plurality of queues; and
circuitry to:
receive, from a compute device over a network link, a compute offload command that is arranged as a fused non-volatile memory command that includes first and second opcodes, the compute offload command to have a block-based compute descriptor that was constructed based on a compute offload request from a computing process hosted by a compute device;
identify a class of service indicated in the block-based compute descriptor; and
store the compute offload command to a queue from among the plurality of queues, the queue previously allocated to the class of service, wherein the block-based compute descriptor included in the compute offload command includes information to be used for execution of a block-based compute operation by compute circuitry at the computational storage server.

2. The network interface device of claim 1, wherein the compute offload command is to be stored to the queue allocated to the class of service in order to shape network traffic associated with compute offload commands received over the network link.

3. The network interface device of claim 1, wherein the class of service is one class of service among a plurality of class of services based on a priority scheme that allocates more queues to a first class of service assigned a higher priority compared to a second class of service assigned a lower priority.

4. The network interface device of claim 1, wherein the block-based compute operation is against virtual objects in a block storage device at the computational storage server, the block storage device to include non-volatile memory.

5. The network interface device of claim 4, comprising the block-based compute descriptor to include storage blocks mapped to the virtual objects, wherein a first group of one or more storage blocks is arranged to be an input for the block-based compute operation and a second group of one or more storage blocks is arranged to be an output for the block-based compute operation.

6. The network interface device of claim 1, the information to be used for execution of the block-based compute operation indicates a function associated with the compute offload request received from the computing process hosted by the compute device, wherein the function is a compression compute operation, a checksum compute operation, a searching compute operation, an image resizing compute operation, a word count compute operation, a video transcoding compute operation, a sorting compute operation, a merging compute operation, a filtering compute operation, a hashing compute operation or a de-duplication compute operation.

7. The network interface device of claim 1, wherein the first opcode included in the fused non-volatile memory command is to provide a transfer of the compute offload command from the compute device to the computational storage server, and the second opcode included in the fused non-volatile memory command is to provide a transfer, to the computing device, of a result of the compute offload request from the computing process.

8. The network interface device of claim 1, wherein the compute offload command arranged as a fused non-volatile memory command is based on a non-volatile memory express over fabrics (NVMe-oF) transport protocol or an internet small computer system interface (iSCSI) transport protocol.

9. At least one machine readable medium comprising a plurality of instructions that in response to being executed by circuitry at a network interface device at a computational storage server, cause the circuitry to:
receive, from a compute device over a network link, a compute offload command that is arranged as a fused non-volatile memory command that includes first and second opcodes, the compute offload command to have a block-based compute descriptor that was constructed based on a compute offload request from a computing process hosted by a compute device;
identify a class of service indicated in the block-based compute descriptor; and
cause the compute offload command to be stored to a queue from among a plurality of queues maintained in a memory at the network interface device, the queue previously allocated to the class of service, wherein the block-based compute descriptor included in the compute offload command includes information to be used for execution of a block-based compute operation by compute circuitry at the computational storage server.

10. The at least one machine readable medium of claim 9, wherein the class of service is one class of service among a plurality of class of services based on a priority scheme that allocates more queues to a first class of service assigned a higher priority compared to a second class of service assigned a lower priority.

11. The at least one machine readable medium of claim 9, wherein the block-based compute operation is against virtual objects in a block storage device at the computational storage server, the block storage device to include non-volatile memory.

12. The at least one machine readable medium of claim 11, comprising the block-based compute descriptor to include storage blocks mapped to the virtual objects, wherein a first group of one or more storage blocks is arranged to be an input for the block-based compute operation and a second group of one or more storage blocks is arranged to be an output for the block-based compute operation.

13. The at least one machine readable medium of claim 9, the information to be used for execution of the block-based compute operation indicates a function associated with the compute offload request received from the computing process hosted by the compute device, wherein the function is a compression compute operation, a checksum compute operation, a searching compute operation, an image resizing compute operation, a word count compute operation, a video transcoding compute operation, a sorting compute operation, a merging compute operation, a filtering compute operation, a hashing compute operation or a de-duplication compute operation.

14. The at least one machine readable medium of claim 9, wherein the first opcode included in the fused non-volatile memory command is to provide a transfer of the compute offload command from the compute device to the computational storage server, and the second opcode included in the fused non-volatile memory command is to provide a transfer, to the computing device, of a result of the compute offload request from the computing process.

15. At least one machine readable medium comprising a plurality of instructions that in response to being executed by circuitry of a computing device cause the circuitry to:
construct a block-based compute descriptor responsive to a compute offload request received from a computing process hosted by a host compute device, the block-based compute descriptor to include an indication of a class of service associated with the compute offload request;
generate a compute offload command arranged as a fused non-volatile memory command that includes first and second opcodes; and
cause the compute offload command to be sent over a network link to a computational storage server, wherein the indication of the class of service in the block-based compute descriptor is to cause a network interface device at the computational storage server to store the compute offload command to a queue allocated to the class of service, the queue to store the compute offload command prior to scheduling a block-based compute operation by compute circuitry at the computational storage server, the block-based compute operation to include use of non-volatile memory maintained at the computational storage server.

16. The at least one machine readable medium of claim 15, wherein the compute offload command is to be stored to the queue allocated to the class of service in order to shape network traffic associated with compute offload commands sent to the computational storage server over the network link.

17. The at least one machine readable medium of claim 15, wherein the class of service is one class of service among a plurality of class of services based on a priority scheme that allocates more queues to a first class of service assigned a higher priority compared to a second class of service assigned a lower priority.

18. The at least one machine readable medium of claim 15, comprising the block-based compute descriptor to include information to be used for execution of the block-based compute operation by the compute circuitry at the computational storage server, wherein the scheduled block-based compute operation is against virtual objects in the non-volatile memory.

19. The at least one machine readable medium of claim 18, comprising the block-based compute descriptor to include storage blocks mapped to the virtual objects, wherein a first group of one or more storage blocks is arranged to be an input for the block-based compute operation and second group of one or more storage blocks is arranged to be an output for the block-based compute operation.

20. The at least one machine readable medium of claim 15, the information to be used for execution of the block-based compute operation indicates a function associated with the compute offload request received from the computing process hosted by the compute device, wherein the function is a compression compute operation, a checksum compute operation, a searching compute operation, an image resizing compute operation, a word count compute operation, a operation, a filtering compute operation, a hashing compute operation or a de-duplication compute operation.

21. The at least one machine readable medium of claim 15, wherein the first opcode included in the fused non-volatile memory command is to provide a transfer of the block-based compute descriptor from the compute device to the computational storage server, and the second opcode included in the fused non-volatile memory command is to provide a transfer of a result of the compute offload request to the computing device from the computational storage server.

22. A system comprising:
a block storage device to include non-volatile memory;
compute circuitry; and
a network interface device that includes circuitry and a memory arranged to maintain a plurality of queues, wherein the circuitry of the network interface device is to:
receive, from a compute device over a network link, a compute offload command that is arranged as a fused non-volatile memory command that includes first and second opcodes, the compute offload command to have a block-based compute descriptor that was constructed based on a compute offload request from a computing process hosted by a compute device;
identify a class of service indicated in the block-based compute descriptor; and
store the compute offload command to a queue from among the plurality of queues, the queue previously allocated to the class of service, wherein the block-based compute descriptor included in the compute offload command includes information to be used for execution of a block-based compute operation by the compute circuitry, the block-based compute operation to be against virtual objects in the non-volatile memory of the block storage device.

23. The system of claim 22, wherein the class of service is one class of service among a plurality of class of services based on a priority scheme that allocates more queues to a first class of service assigned a higher priority compared to a second class of service assigned a lower priority.

24. The system of claim 22, the information to be used for execution of the block-based compute operation indicates a function associated with the compute offload request received from the computing process hosted by the compute device, wherein the function is a compression compute operation, a checksum compute operation, a searching compute operation, an image resizing compute operation, a word count compute operation, a video transcoding compute operation, a sorting compute operation, a merging compute operation, a filtering compute operation, a hashing compute operation or a de-duplication compute operation.

25. The system of claim 22, wherein the first opcode included in the fused non-volatile memory command is to provide a transfer of the compute offload command from the compute device to the network interface device, and the second opcode included in the fused non-volatile memory command is to provide a transfer, to the computing device, of a result of the compute offload request from the computing process.
